(19) United States
(12) Patent Application Publication
(10) Pub. No.: US 2013/0017002 A1
(43) Pub. Date: Jan. 17, 2013

(54) DEVELOPER LAYER RESTRICTION MEMBER AND DEVELOPMENT APPARATUS

(71) Applicant: Tadanobu Yoshikawa, Toride-shi (JP)

(72) Inventor: Tadanobu Yoshikawa, Toride-shi (JP)

(73) Assignee: CANON KABUSHIKI KAISHA, Tokyo (JP)

(21) Appl. No.: 13/541,143

(22) Filed: Jul. 3, 2012

(30) Foreign Application Priority Data
Jul. 11, 2011 (JP) 2011-153162

(51) Int. Cl. G03G 15/09

(52) U.S. Cl. 399/274

(57) ABSTRACT

The typical configuration of the present invention includes a developer layer restriction member (41) for restricting a developer amount held on a rotatable development sleeve (4c) which carries a developer and conveys the developer to a development region opposite to a photoconductor drum (1), the developer being made by mixing a non-magnetic toner and a magnetic carrier. The present invention includes a substrate resin plate made of a resin, and a resin hard coat layer (41b) disposed on a surface of the developer layer restriction member (41), the resin hard coat layer being made by coating the substrate resin plate with a resin which is harder than the resin of the substrate resin plate.

### BACKGROUND OF THE INVENTION

1. Field of the Invention

The present invention relates to a development apparatus using a two-component developer which is made by mixing a non-magnetic toner and a magnetic carrier, and a developer layer restriction member to be used for the same.

2. Description of the Related Art

As a development apparatus used for a conventional image forming apparatus, there is a development apparatus of two-component development system which uses a two-component developer which is made by mixing a non-magnetic toner and a magnetic carrier. Comparing to a one-component development system which does not use a magnetic carrier, this two-component development system requires many members for constituting a development apparatus, thereby raising the cost for the development apparatus. Therefore, it has been attempted to replace the metal molded parts of the members constituting the two-component development apparatus with resin molded parts.

Here, as described in Japanese Patent Application Laid-Open No. 11-133733, particularly in the one-component development apparatus, it has been already performed that a developer layer restriction member, which restricts a developer amount on a development roller, is made by a resin molded part.

However, in the two-component development apparatus, if the developer layer restriction member is made by a resin molded part, two problems will be raised as follows.

To begin with, the first problem is described. A developer puddle is formed on an upstream side in a rotation direction of a development roller of a developer layer restriction member. Accordingly, when a developer passes through between a restriction portion of the developer layer restriction member and a development roller, a large friction force is generated between the developer layer restriction member and the developer. At this time, if the developer layer restriction member is a metal molded part, almost no friction force is generated at the developer layer restriction member. However, if the developer layer restriction member is a resin molded part, as the two-component development apparatus is being used, a frictional wear of the restriction portion of the developer layer restriction member gradually progresses.

When the frictional wear at the restriction portion of the developer layer restriction member has progressed, the distance between the restriction portion of the developer layer restriction member and the development roller surface becomes larger than the desired value, so that the amount of the developer carried on the development roller after being restricted by the development layer restriction member becomes larger than the desired amount. At this time, in the development region which is opposite to the development roller and a photoconductor drum, the developer may stagnate so that an overflow of the developer, a carrier adhesion to the photoconductor drum, an image degradation, such as a toner adhesion to a non-image portion (so called fog), may be caused.

Next, the second problem is described. When the developer layer restriction member is a resin molded part, comparing to a metal molded part, the surface roughness (unevenness) thereof is large, and the resin molded part is an insulator, so that fine powders of the toner or external additives are very easily adhered to the surface of the developer layer restriction member so as to be fixed thereon. FIG. 12C is a schematic diagram illustrating a state around the developer layer restriction member when the development apparatus is used under high temperature and high humidity, in a case that a conventional developer layer restriction member of a resin molded part is used. As illustrated in FIG. 12C, particularly, when the two-component development apparatus is used under high temperature and high humidity, due to a softening of the toner resin and an intervention of water, the adhesion force produced between the surface of the developer layer restriction member and the fine powders of the toner or the external additives becomes large and prominent.

Then, on the surface of a developer layer restriction member 41, particularly adjacent to the restriction portion, clusters of the fine powders of the toner or the external additives grow. In such a case, the distance between the restriction portion of the developer layer restriction member 41 and the surface of the development roller (development sleeve 4c) becomes smaller than the desired value, so that the amount of the developer carried on the development roller after being restricted by the development layer restriction member 41 becomes smaller than the desired amount. At this time, in the development region which is opposite to the development roller and the photoconductor drum, due to the decrease of the contacting area between the developer and the photoconductor drum and the decrease of the toner amount, an image degradation, such as a density reduction of an image, may be caused.

Therefore, the present invention is intended to provide a developer layer restriction member which can suppress a developer overflow, a carrier adhesion to the photoconductor drum, a toner adhesion to a non-image portion, and an image degradation, such as a density reduction of an image, even when a developer layer restriction member of a two-component development apparatus is made by a resin molded part.

### SUMMARY OF THE INVENTION

In order to solve the above problem, there is provided a typical developer layer restriction member and development apparatus. The developer layer restriction member restricts a developer amount held on a rotatable developer carrier which carries a developer and conveys the developer to a development region opposite to an image bearing member, the developer being made by mixing a non-magnetic toner and a magnetic carrier. The developer layer restriction member includes a substrate resin plate made of a resin and a resin hard coat layer disposed on a surface of the developer layer restriction member, the resin hard coat layer being made by coating the substrate resin plate with a resin which is harder than the resin of the substrate resin plate.

According to the present invention, even when the developer layer restriction member of the two-component development apparatus is made by a resin molded part, a developer overflow, a carrier adhesion to the photoconductor drum, a toner adhesion to a non-image portion, and an image degradation, such as a density reduction of an image, can be suppressed.

Further features of the present invention will become apparent from the following description of exemplary embodiments with reference to the attached drawings.

### BRIEF DESCRIPTION OF THE DRAWINGS

FIG. 1 is a constitutional diagram of an image forming apparatus according to a first embodiment;

FIG. 2 is a constitutional diagram of an image forming unit according to the first embodiment;

FIG. 3A is a constitutional diagram of a developer layer restriction member according to the first embodiment; FIG. 3B is a constitutional diagram of another developer layer restriction member according to the first embodiment;

FIG. 4A is a graph illustrating a measurement result of an ionization potential of a magnetic carrier material of the first embodiment; FIG. 4B is a graph illustrating a measurement result of an ionization potential of a resin hard coat layer material of the first embodiment;

FIG. 5A is a partial cross-sectional view of the developer layer restriction member according to the first embodiment; FIG. 5B is a table of physical properties of a substrate resin plate of the developer layer restriction member and the resin hard coat layer, respectively;

FIGS. 6A to 6D are drawings illustrating a forming method of the resin hard coat layer of the developer layer restriction member according to the first embodiment;

FIG. 7 is a relationship graph illustrating changes of a developer amount per unit area which is carried on a developer carrier with respect to a number of printed sheets, in respective cases that a conventional developer layer restriction member is used, and the developer layer restriction member of the first embodiment is used;

FIG. 8A is a partial constitutional diagram of a developer layer restriction member according to a second embodiment; FIG. 8B is a relationship graph illustrating, in the developer layer restriction member according to the second embodiment, a relationship between an addition amount of fluoride particles added in the resin hard coat layer and a pure water contact angle on a surface of the developer layer restriction member;

FIG. 9A is a partial constitutional diagram of a developer layer restriction member according to a third embodiment; FIG. 9B is a relationship graph illustrating, in the developer layer restriction member according to the third embodiment, a relationship between a conductive particle addition amount added in the resin hard coat layer and a surface resistance of the resin hard coat layer;

FIG. 10 is a partial constitutional diagram of a developer layer restriction member according to a fourth embodiment;

FIG. 11 is a relationship graph illustrating changes of a developer amount per unit area which is carried on a developer carrier with respect to a number of printed sheets, in respective cases that a conventional developer layer restriction member is used, and the developer layer restriction member of the fourth embodiment is used;

FIG. 12A is a schematic diagram illustrating the developer layer restriction member, the developer carrier, and an initial state of a developer carried on the developer carrier, in the case that the conventional developer layer restriction member is used; FIG. 12B is a schematic diagram illustrating the developer layer restriction member, the developer carrier, and a state, after long-term use, of a developer carried on the developer carrier, in the case that the conventional developer layer restriction member is used; and FIG. 12C is a schematic diagram illustrating a state, after long-term use, of a toner contamination on a surface of the developer layer restriction member in the case that the conventional developer layer restriction member is used. FIG. 12D is a schematic diagram illustrating a state, after long-term use, of a toner contamination on a surface of the developer carrier in the case that the conventional developer layer restriction member is used.

### DESCRIPTION OF THE EMBODIMENTS

### First Embodiment

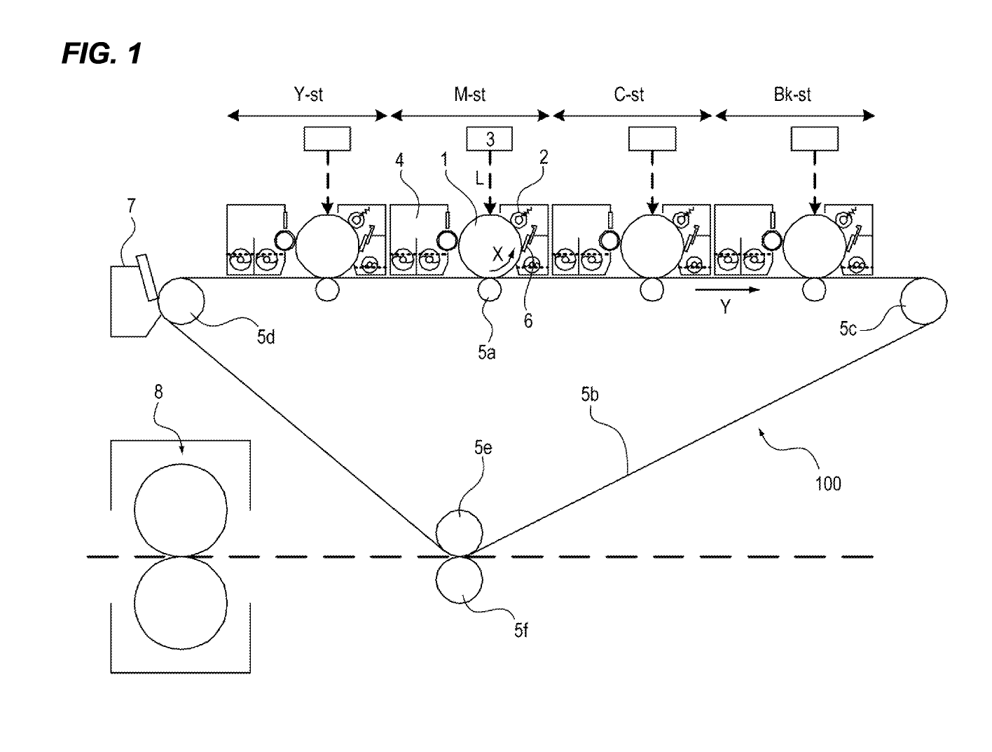

The first embodiment of the developer layer restriction member and the development apparatus according to the present invention is described with reference to the drawings. FIG. 1 is a constitutional diagram of the image forming apparatus according to this embodiment.

As illustrated in FIG. 1, an image forming apparatus 100 of this embodiment includes an endless intermediate transfer belt 5b traveling in the direction of arrow Y. Above the intermediate transfer belt 5, image forming units Y-st, M-st, C-st, Bk-st, which form toner images of yellow, magenta, cyan, and black, are disposed.

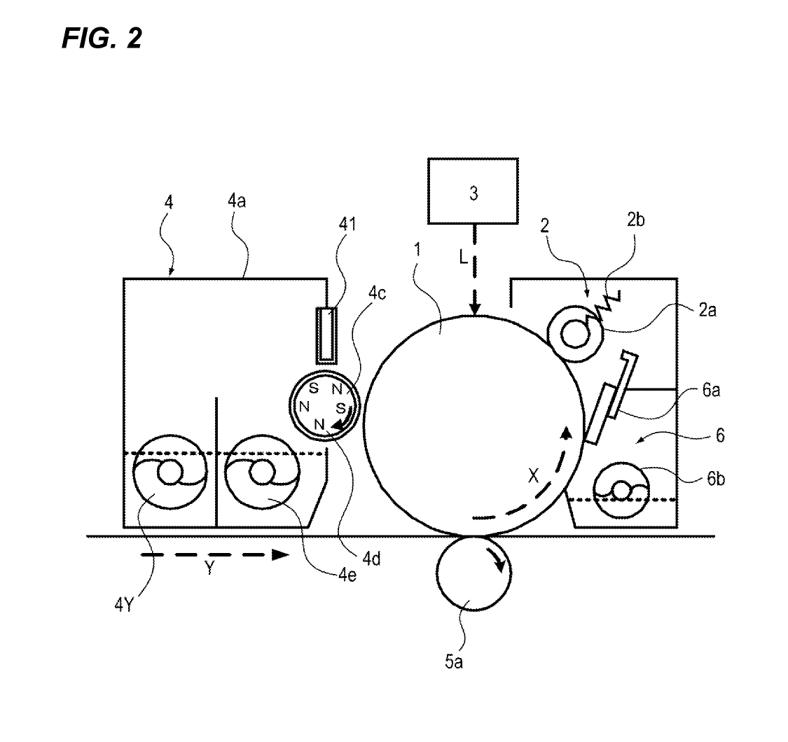

As illustrated in FIG. 2, each of the image forming units Y-st, M-st, C-st, Bk-st includes a photoconductor drum (image bearing member) 1. The photoconductor drum 1 is an organic photoconductor (OPC) whose charging characteristics is a negative chargeability, and the outer diameter thereof is 30 mm. The photoconductor drum 1 is driven to rotate in the direction of arrow X at a process speed (circumferential velocity) of 100 mm/sec about the central support shaft.

The surface of the photoconductor drum 1 is uniformly processed so as to be charged by a charging device 2. The charging device 2 adopts a contact charging system by a charging roller 2a. The charging roller 2a is pressed by a pressing spring 2b against the photoconductor drum 1 with a given pressing force, and rotates coordinately with a rotation of the photoconductor drum 1.

By applying a charging bias voltage to the charging roller 2a, the circumferential surface of the photoconductor drum 1 is processed so as to be charged by contact to a given polarity and voltage. The charging bias voltage of this embodiment is an oscillation voltage generated by superimposing a DC voltage of −600 V and an AC voltage which is a sine wave having a frequency f of 1.5 kHz, and a peak-to-peak voltage of 1500 Vpp. The circumferential surface of the photoconductor drum 1 is uniformly processed so as to be charged by contact to −600 V (dark potential Vd).

The charged photoconductor drum 1 is irradiated with a laser beam by a laser beam unit 3 according to an image information so as to form an electrostatic latent image. The electrostatic latent image is developed as a toner image by a development apparatus 4 with toners of respective colors. In the case of this embodiment, a toner is adhered to an exposure bright portion on the surface of the photoconductor drum 1 so as to reversely develop an electrostatic latent image.

As illustrated in FIG. 1, the toner images of respective colors formed on the photoconductor drum 1 are primarily transferred to an intermediate transfer belt 5b by a primary transfer roller 5a so as to be superposed. The intermediate transfer belt 5b is wound around a drive roller 5c, a tension roller 5d, and a counter roller 5e. The remaining toners, which have remained on the photoconductor drum 1 after the primary transfer, are removed and collected from the photoconductor drum 1 by a cleaning blade 6a of a photoconductor drum cleaning device 6.

The toner images formed on the intermediate transfer belt 5b are transferred as a whole to a sheet P conveyed from a sheet tray (not shown) by a nip portion (secondary transfer portion) between a secondary transfer roller 5f and the intermediate transfer belt 5b. The sheet P, on which the toner images have been transferred, is heated and pressed by a fixing device 8 so as to fix the toner images, and discharged outside the device. The remaining toners, which have remained on the intermediate transfer belt 5b after the secondary transfer, are cleaned by an intermediate transfer belt cleaning device 7.

(Development Apparatus 4)

In the developing apparatus 4 of two-component development system, a two-component developer made of a non-magnetic toner and a magnetic carrier is stored, and its mixing ratio is about 1:9 in a weight ratio. This ratio should be properly adjusted according to a charging amount of toner, a carrier particle size, and the like, and this numerical value is not always needed to be followed.

The development apparatus 4 is opened at a developing region which is opposite to the photoconductor drum 1, and a development sleeve (developer carrier) 4c is rotatably disposed so as to be partially exposed to this opening portion. The development sleeve 4c is disposed so as to be adjacent and opposite to the photoconductor drum 1 while keeping the minimum close distance (which is called “S-D gap” hereunder) to the photoconductor drum 1 at 300 μm. The portion thereof opposite to the photoconductor drum 1 is the development region.

The development sleeve 4c is made by a non-magnetic material, and a part of the developer in the developing container 4a is absorbed and held as a magnetic brush layer by a magnetic force of a magnet (magnetic field generating means) 4d which is fixed in the development sleeve 4c. The developer held on the surface of the development sleeve 4c is rotationally conveyed due to the rotation of the development sleeve 4c, and is restricted by the developer layer restriction member 41, thereby becoming the magnetic brush layer of a desired developer amount, and makes contact with the surface of the photoconductor drum 1 in the development region. The developer layer restriction member 41 is disposed adjacent to and opposite to the development sleeve 4c while keeping a constant distance (which is called “S-B gap” hereunder) with respect to the development sleeve 4c. In this embodiment, the S-B gap is set to be 400 μm.

A given development bias is applied to the development sleeve 4c from a power source (not shown), and the toner in the developer conveyed to the development region by the development sleeve 4c is adhered by an electric field due to the development bias corresponding to an electrostatic latent image on the surface of the photoconductor drum 1 so as to be developed as a toner image. In this embodiment, the development bias is an oscillation voltage generated by superimposing a DC voltage of −350 V and an AC voltage which is a rectangular wave having a frequency f of 8.0 kHz, and a peak-to-peak voltage of 1.8 kV.

The developer after developing the electrostatic latent image is conveyed by the rotation of the development sleeve 4c, and is collected in the developing container 4a. The developer in the developing container 4a is circulated in the developing container 4a by a development screw (first developer stirring and conveying member) 4e and a stirring screw (second developer stirring and conveying member) 4f so as to be mixed and stirred again. Both the development screw 4e and the stirring screw 4f have the central shaft diameter of 7 mm and an outer diameter of 14 mm.

(Two-component Developer)

The two-component developer (a non-magnetic toner and a magnetic carrier) used in this embodiment is described.

The non-magnetic toner is made by colored resin particles including a binder resin, a coloring agent, and other charging control agents, an additive agent, such as wax. For example, inorganic oxide fine particles, such as a colloidal silica, a titania, and the like, are externally added to the surface of the colored resin fine particles according to the need of an improvement of fluidity, or an adjustment of charging amount, and the like. The toner of this embodiment includes a polyester resin as a binder resin, and has a resistance value of about 10 ¹⁴ Ωcm, and a volume average particle diameter D₄ of about 6.0 μm.

The volume average particle diameter D₄ of the toner is measured by a Coulter counter TA-II type (manufactured by Coulter Corporation). As a measurement method, a surfactant (preferably, an alkyl benzene sulfonic acid salt) as a dispersing agent of 0.1 to 5 ml is added to an electrolyte of 100 to 150 ml made of a 1% NaCl aqueous solution which has been prepared by using a primary sodium chloride, and a measurement test portion of 2 to 20 mg is further added. The electrolyte, into which the test portion has been suspended, is processed to be dispersed in an ultrasonic dispersing device for about 1 to 3 minutes, and is measured by the above-mentioned Coulter counter TA-II type with 100 μm aperture with respect to a toner volume of 2 μm or more. With this, a volume distribution is calculated, and a volume average particle diameter is determined as a median diameter of 50% volume based on the measurement result.

The magnetic carrier is formed by a surface coat resin covering a magnetic core and a magnetic core surface. As the magnetic core, a magnetic carrier core, such as a known ferrite particle, a magnetite particle, a resin carrier core of magnetic material distribution type, can be used. For example, there can be mentioned, for example, ferrite particles or magnetite particles including one or two or more kinds of elements selected from iron, lithium, beryllium, magnesium, calcium, rubidium, strontium, nickel, copper, zinc, cobalt, manganese, chromium, and titanium. Preferably, it is the magnetite particles or the magnetic ferrite particles including one or two or more kinds of elements selected from copper, zinc, manganese, calcium, lithium, and magnesium.

The surface coat resin is preferred to have a high wettability with respect to a ferrite component, and can be any of a thermoplastic resin or a thermosetting resin. As the thermoplastic resin, there are polystyrene, polymethyl methacrylate, styrene-acrylic acid ester copolymer, styrene-methacrylic acid ester copolymer, styrene-butadiene copolymer, ethylene-vinyl acetate copolymer, polyvinyl chloride, polyvinyl acetate, polyvinylidene fluoride resin, fluorocarbon resin, perfluorocarbon resin, solvent soluble perfluorocarbon resin, polyvinyl pyrrolidone, petroleum resin, novolac resin, saturated alkyl polyester resin, polyethylene telephthalate, polybuthylene telephthalate, aromatic polyester resin, such as polyarylate, polyamide resin, polyacetal resin, polycarbonate resin, polyether sulfone resin, polysulfone resin, polyphenylene sulfide resin, and polyether ketone resin. As the thermosetting resin, there are phenol resin, modified phenol resin, maleic resin, alkyd resin, epoxy resin, acrylic resin, unsaturated polyester obtained by polycondensation of maleic anhydride and terephtalic acid and polyhydric alcohol, urea resin, melamine resin, urea-melamine resin, xylene resin, toluene resin, guanamine resin, melamine-guanamine resin, acetoguanamine resin, guriputaru resin, furan resin, silicone resin, polyimide, polyamide-imide resin, polyetherimide resin, and polyurethane resin. In this embodiment, there was used a silicone resin obtained by modifying a slate silicone resin with alkyd, polyester, epoxy, urethane, and the like.

The number average particle diameter of the magnetic carrier is about 35 μm. The volume average particle diameter of the magnetic carrier is measured by a flow-type particle image analyzing device FPIA3000 (manufactured by Sysmex Corporation) such that a range of 0.5 to 200 μm is divided into 32 logarithm, and the number of particles is measured for every channel. Then, based on the measurement result, the median diameter of number 50% is determined as the number average particle diameter.

(Developer Layer Restriction Member 41)

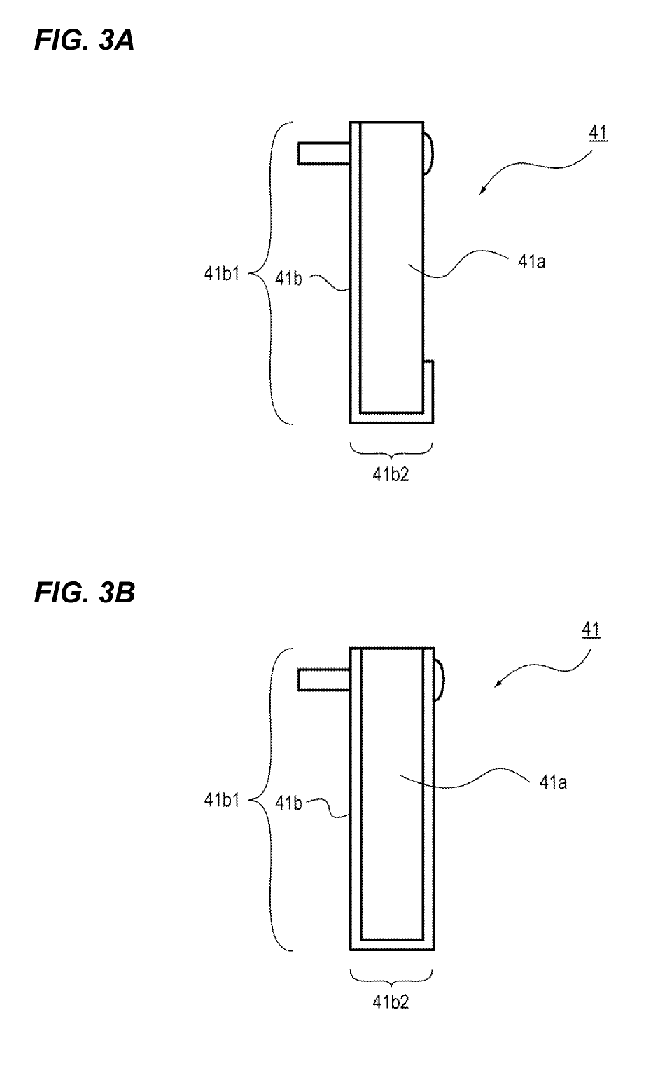

FIG. 3A is a constitutional diagram of the developer layer restriction member 41 according to this embodiment. As illustrated in FIG. 3A, the developer layer restriction member 41 includes a substrate resin plate 41a (plane plate) as a substrate, and a resin hard coat layer 41b. The coat layer 41b is made by coating the substrate resin plate 41a in order to improve the wear resistance and the rub resistance of the substrate resin plate 41a.

The shape of the substrate resin plate 41a of this embodiment has the thickness of 3 mm and the longitudinal length of 320 mm. The longitudinal length of the developer layer restriction member 41 is set to be larger than the developer carrying width by development sleeve 4c because the developer on the development sleeve 4c needs to be restricted uniformly in the longitudinal direction. Note that, the developer carrying width of the development sleeve 4c is set to be larger than the maximum image width in order to ensure the maximum image width which can be output by the image forming apparatus 100 of this embodiment.

The coat layer 41b is preferred to be disposed in a region where the developer of the developer layer restriction member 41 makes contact with. Specifically, as illustrated in FIG. 3A, there are preferably disposed a developer puddle contacting surface 41b1, a restriction surface 41b2, and the coat layer 41b. The developer puddle contacting surface 41b1 is formed on the upstream side in the advancement direction of the development sleeve 4c of the developer layer restriction member 41. The restriction surface 41b2 is opposite to the development sleeve 4c. The coat layer 41b is disposed at a portion of the surface on the opposite side of the developer puddle contacting surface 41b1. However, the coat layer process region to the developer layer restriction member 41 is not limited to this, and can be disposed on all over the substrate resin plate 41a as illustrated in FIG. 3B. With this, the coat process mentioned below can be performed easily.

As the material for the substrate resin plate 41a, a polyolefin resin, such as polyethylene, polypropylene, a polystyrene resin, such as polystyrene, ABS, an acrylic resin, and a polyester resin, such as polyethylene terephthalate, polyethylene naphthalate, are preferable in terms of strength, moldability, cost, and the like. ABS resin is used for this embodiment.

As the material for the coat layer 41b, there are mentioned urethane resin, alkyd resin, acrylic resin, silicone resin, polyester resin, polyimide resin, and the like. In this embodiment, there was used an acrylic resin which is the most excellent in terms of the wear resistance and the rub resistance. More specifically, there was used an acrylic UV curing hard coat material (DeSolite manufactured by JSR Corporation) including, as a main component, a polyfunctional acrylate, such as pentaerythritol tetraacrylate, 2-acryloyl oxyethyl, and the like. After applying this acrylic UV curing hard coat material (UV curing resin) to the substrate resin plate surface of the developer layer restriction member 41, the coat layer 41b was formed by irradiating UV thereon so as to be cured.

Here, the relationship of the material of the coat layer 41b with respect to the developer is described. In the image forming apparatus 100 of this embodiment, the polarity of the toner is negative in order to perfume a reveres development by the development apparatus 4 on the photoconductor drum 1 which has been processed to be negatively charged. The materials are design such that, when the magnetic carrier and the toner are frictionally charged in the development apparatus 4, in the series of frictional charging, the magnetic carrier is charged on the positive side, and the toner is charged on the negative side.

Also in the frictional charging of the coat layer 41b and the magnetic carrier, the materials are designed such that the coat layer surface is charged on the negative side which is the same polarity as that of the toner. With this, the adhesion of toner to the coat layer surface is suppressed. Namely, by the magnetic carrier having high potential as a donor which provides electrons to the counterpart by the frictional charging, both the toner and the coat layer are charged in the same polarity of negative, a repulsive force is generated between the toner and the coat layer 41b, thereby preventing the toner from adhering to the coat layer surface.

A method of confirming the charging polarity of the coat layer 41b after being frictionally charged with the magnetic carrier, there is a method in which the developer layer restriction member 41 including the coat layer 41b is disposed obliquely, after a given amount of the magnetic carrier has been flown down thereon, the voltage of the coat layer surface is measured. Actually, in the case of the acrylic UV curing-type hard coat material used in this embodiment, the voltage of the coat layer surface was the negative polarity.

The charging series of the coat layer 41b and the toner have very small potentials as donor for providing electrons by the frictional charging to the counterpart. Therefore, even when the coat layer 41b and the toner are frictionally charged, the changes of the surface voltages (or charging amounts) are small for both of them so that the material design does not need to take them into account.

When selecting the material for the coat layer 41b taking into account the frictional charging series with the magnetic carrier, the charging polarity of the coat layer 41b may be confirmed by the above-mentioned method in which the magnetic carrier and the coat layer 41b are actually frictionally charged. However, the method in which the ionization potentials of respective materials are measured and compared with one another is simple and excellent in stability.

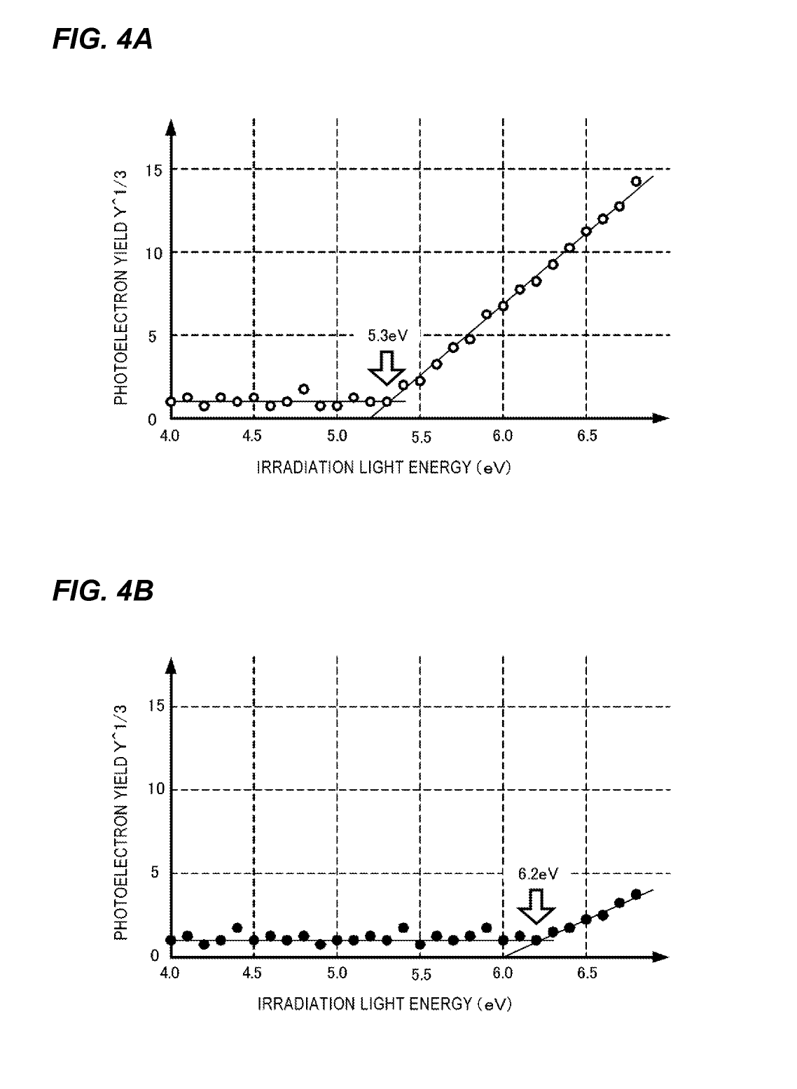

FIG. 4A is a graph illustrating the measurement result of the ionization potential of the magnetic carrier material of this embodiment. FIG. 4B is a graph illustrating the measurement result of the ionization potential of the material of the coat layer 41b of this embodiment. The photoelectron spectroscopic device AC-2 manufactured by Riken-Keiki Corporation was used for measuring the ionization potentials.

As shown in FIG. 4A, the photoelectron emission amounts are measured when the UV having respective energies are irradiated, while the energy of the UV, which is the incident beam irradiated on the measurement samples (magnetic carriers), is gradually increased from the low energy side (4.0 eV in FIG. 4A). The number of emitted photoelectrons drastically increases the inflection point shown by the arrow in FIG. 4A. This inflection point is the ionization potential of the measurement sample (magnetic carrier). From the result of FIG. 4A, it can be found that the ionization potential of the magnetic carrier material is 5.3 eV. Moreover, from the result of FIG. 4B, it can be found that the ionization potential of the material of the coat layer 41b is 6.2 eV.

Here, the ionization potential is a minimum energy required for emitting an electron, and as the ionization potential of the material becomes lower, the material itself is more easily charged in positive by emitting an electron (i.e., the potential as donor is larger). Comparing the ionization potentials of the materials of the magnetic carrier and the coat layer 41b, the ionization potential of the magnetic carrier material is smaller. Accordingly, it can be found that the magnetic carrier is charged in positive by emitting an electron, and the coat layer 41b is charged in negative by receiving the electron from the magnetic carrier. Note that, the ionization potential of the toner used in this embodiment was 5.7 eV.

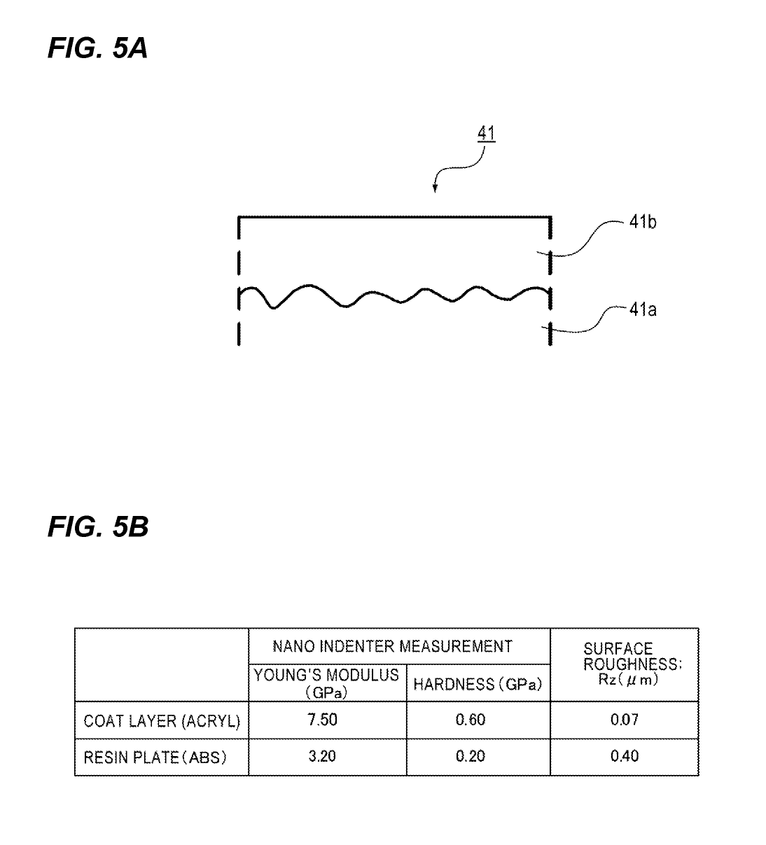

FIG. 5A is a partial cross-sectional view of the developer layer restriction member 41 according to this embodiment. FIG. 5B is a table showing the Young's modulus, the hardness, the surface roughness (ten-point average roughness: Rz) of the substrate resin plate 41a (ABS resin in this embodiment) and the coat layer 41b (UV curing-type acryl resin in this embodiment) of the developer layer restriction member 41, respectively.

The Young's modulus and the hardness were measured by Nano Indenter G200 manufactured by Agilent Technologies Corporation. As the measurement method, the probe of the indenter is pressed against the respective surfaces of the substrate resin plate 41a and the coat layer 41b, and the load curve and the unload curve are measured when the maximum stress is 300 μN. Then, based on the measured load/unload profiles, the Young's modulus and the hardness are calculated. As a result, it is found that, comparing to the ABS resin of the substrate resin plate 41a, the hardness of the UV curing-type acryl resin of the coat layer 41b is about three times, and the coat layer 41b is excellent in terms of the wear resistance and the rub resistance.

The surface roughness (ten-point average roughness: Rz) was measured by the contact-type surface roughness tester SE3500 manufactured by Kosaka Laboratory. As a result, it is found that, comparing to ABS resin of the substrate resin plate 41a, the surface roughness (ten-point average roughness: Rz) of the UV curing-type acryl resin of the coat layer 41b is very small, and the coat layer surface is very smooth. This is because the leveling property of the UV curing-type resin is very excellent. By improving the smoothness of the surface by providing the coat layer 41b on the surface, fine powders of the toner and external additives are prevented from entering the recess portion of the surface of the developer layer restriction member 41 so as to be accumulated therein and contaminate the same.

With this, fine powders of the toner and external additives are prevented from being fixedly adhered to the surface of the developer layer restriction member. With this, the distance between the restriction portion of the development layer restriction member 41 and the development sleeve surface becomes smaller than the desired value. Therefore, the developer amount carried on the development sleeve after being restricted by the developer layer restriction member is suppressed to become smaller than the desired amount. Accordingly, in the development region where the development sleeve 4c and the photoconductor drum 1 are opposite to each other, the decrease of the contact area between the developer and the photoconductor drum 1 and the decrease of the toner amount can be suppressed, so that an image degradation, such as a density reduction of an image, can be suppressed.

The thickness of the coat layer 41b is preferred to be in the range of 1 to 9 μm, and is about 5 μm in this embodiment. When the thickness of the coat layer 41b is smaller than 1 μm, although depending on the surface roughness of the substrate resin plate 41a, it may be impossible to sufficiently improve the smoothness after providing the coat layer 41b. When the thickness of the coat layer is larger than 9 μm, the thickness of the UV curing-type resin, which is applied for forming the coat layer, becomes too large so that the UV cannot reach the internal potion of the coat layer, and the curing may become insufficient.

Here, the method of measuring the film thickness of the coat layer 41b is described. As the film thickness measurement sample, the developer layer restriction member 41 provided with the coat layer 41b is cut out in the cross-sectional direction. At this time, the position where the developer layer restriction member 41 is cut out is at five portions, i.e., the both end portions, the central portion, and intermediate portions between the both end portions and the central portion in the longitudinal direction, and the cut out thickness (longitudinal length) of the sample is 2 mm. After that, the cross section of the cut out sample was figured by a diamond knife of Microtome, and observed by using a scanning electron microscope (S-4700 manufactured by Hitachi Corporation), and the film thickness of the coat layer 41b was measured. The film thickness measurement of the coat layer 41b was performed at 10 points on one sample, and the film thickness of the coat layer was determined as the average value of the film thickness at 50 points in total, i.e., (five samples ×10 point measurement).

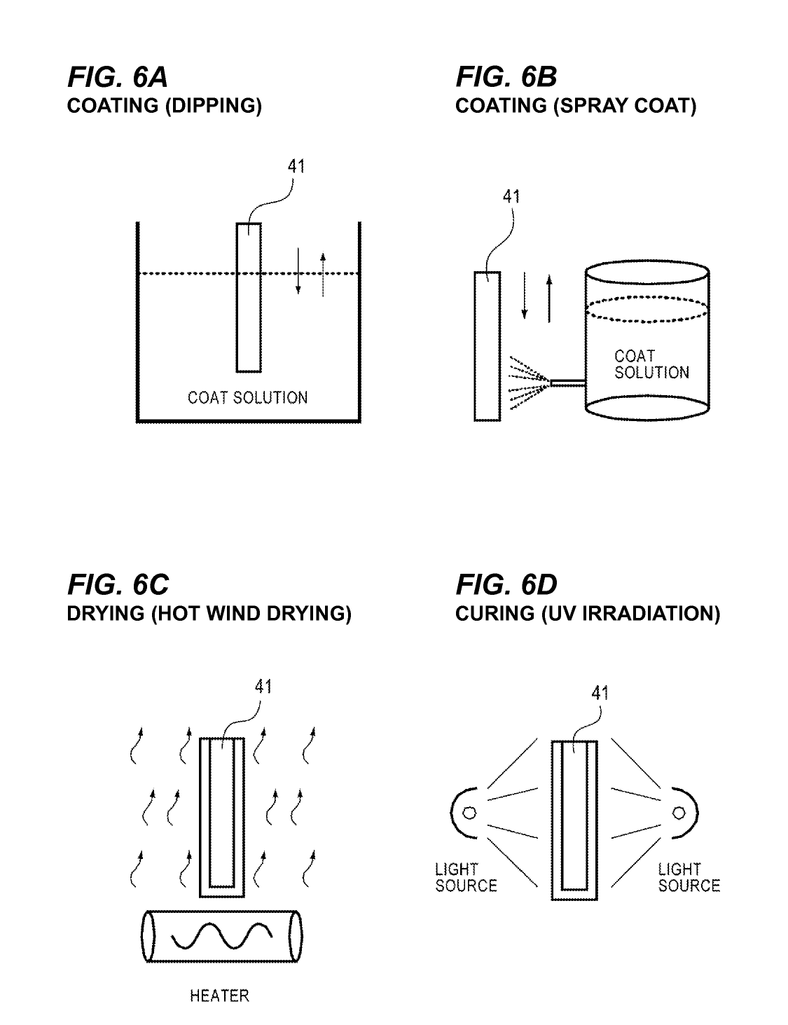

Next, referring to FIGS. 6A to 6D, the method of forming the coat layer 41b on the surface of the developer layer restriction member 41 is described.

(1) Coating Solution

The coating solution is prepared by combining pentaerythritol tetraacrylate which is polyfunctional acrylate as resin component, 2-acryloyl oxyethyl of about 30 wt %, methyl ethyl ketone as diluents solvent, methyl isobutyl ketone of about 68 wt %, and Ingacure 907 of about 2 wt % as polymerization initiator.

(2) Coating Process

As a main method of coating the coating solution on the developer layer restriction member 41 is the dipping method illustrated in FIG. 6A and the spray coat method illustrated in FIG. 6B.

First, the dipping method is described. The substrate resin plate of the developer layer restriction member 41 without the portions to be coated is masked with a polyimide tape (manufactured by 3M Corporation). Then, as illustrated in FIG. 6A, under the environment in which the temperature is about 25° C., and the relative humidity is 50% RH or less, the masked developer layer restriction member 41 is dipped into the coating solution in the container which is shielded against UV. After that, the developer layer restriction member 41 is pulled up at a constant speed, so as to form a coat film on the surface of the developer layer restriction member 41. Here, the film thickness of the coat film can be adjusted by changing the pulling up speed of the developer layer restriction member 41 with respect to the coating solution.

Next, the spray coat method is described. Similar to the dipping method, the substrate resin plate of the developer layer restriction member 41 without the portions to be coated is masked by the polyimide tape. Then, as illustrated in FIG. 6B, under the environment in which the temperature is about 25° C., and the relative humidity is 50% RH or less, the spray gun is moved at a constant speed with respect to the masked developer layer restriction member 41. With this, the coat film is formed on the surface of the developer layer restriction member 41. Here, the film thickness of the coat film can be adjusted by changing the speed of the spray gun and the discharge pressure of the spray gun.

(3) Dry Process

As illustrated in FIG. 6C, the coat film, which has been coated on the surface of the developer layer restriction member 41 during the coating process, is dried for about 1 to 5 minutes with a hot wind in a drying furnace in which the temperature is 50 to 100° C., and the relative humidity is 20% RH or less, so as to remove the remaining solvent in the coat film. In this embodiment, there was performed a hot wind drying in which the temperature was 75° C., the relative humidity was 10 %RH, and the drying time was 2 minutes.

(4) UV Curing Process

After the drying process, as illustrated in FIG. 6D, UV is irradiated by the UV irradiation device (brand name: UE06/81-3; manufactured by Eye Graphics Corporation) on the coat film on the surface of the developer layer restriction member 41. With this, the coat layer as a cured film can be obtained on the surface of the developer layer restriction member 41. Here, as the irradiation condition of UV, an integrated light quantity is preferred to be in a range from 1000 mJ/cm² to 3000 mJ/cm². This is because the coat film may not be cured sufficiently uniformly when the integrated light quantity is less than 1000 mJ/cm², and the substrate resin surface of the developer layer restriction member 41 may be degraded when the integrated light quantity is more than 300 mJ/cm². In this embodiment, the integrated light quantity as the irradiation condition of UV is set to be 1000 mJ/cm².

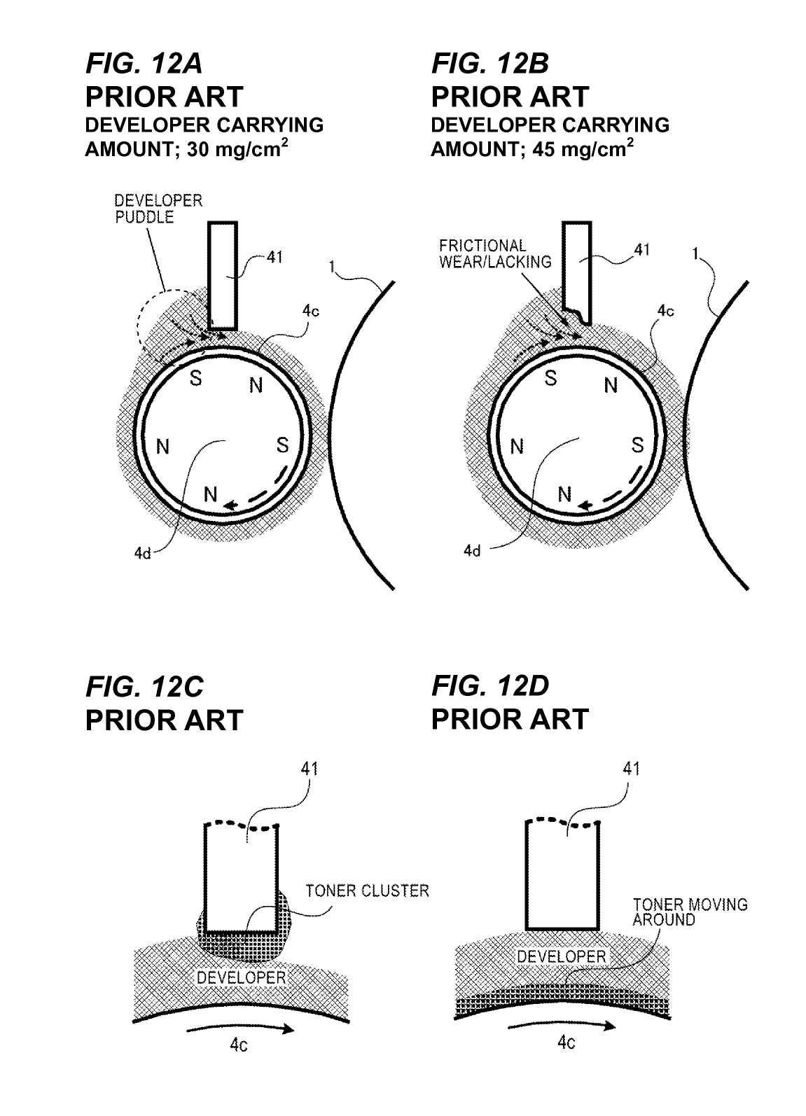

Next, the effect of the developer layer restriction member 41 including the coat layer 41b is described. FIG. 12A is a drawing illustrating a state of initial use of the conventional developer layer restriction member 41 including no coat layer 41b. FIG. 12B is a drawing illustrating a state of the conventional developer layer restriction member 41 including no coat layer 41b after the development apparatus 4 has been used for a long period (after printing forty thousand sheets).

As illustrated in FIG. 12A, the developer carried on the surface of the development sleeve 4c is restricted by the developer layer restriction member 41. The developer amount on the surface of the development sleeve 4c at the development region opposite to the surface of the photoconductor drum 1 is 30 mg/cm². At this time, on the upstream side in the rotation direction of the development sleeve 4c of the developer layer restriction member 41, the developer, which has been restricted by the developer layer restriction member 41, becomes excess and is accumulated, thereby forming a developer puddle. The developer in the developer puddle receives a magnetic force working in the tangential direction of the development sleeve 4c by the magnetic pole of the magnet 4d contained in the developer layer restriction member 41, and a force due to a physical conveying force on the surface of the development sleeve 4c, and makes contact with the developer layer restriction member 41 with a large pressure. Specifically, at the restriction portion of the developer layer restriction member 41 actually restricting the developer on the development sleeve 4c, the pressure by the developer in the developer puddle becomes the largest.

At the portion where the pressure of the developer against the developer layer restriction member 41 becomes large, the friction force working between the developer and the developer layer restriction member 41 also becomes large, so that frictional wear or lacking may be generated if the developer layer restriction member 41 is made by resin molded part. As illustrated in FIG. 12B, when performing a printing operation of forty thousand sheets by using the development apparatus 4, a portion of the restriction portion of the developer layer restriction member 41 is frictionally worn by the friction with the developer, so that the S-B gap, which is the distance between the restriction surface of the developer layer restriction member 41 and the development sleeve 4c, becomes larger. As a result, the developer amount on the surface of the development sleeve 4c at the development region opposite to the surface of the photoconductor drum 1 becomes 45 mg/cm², so as to become much larger than the desired developer amount (30 mg/cm² at the initial use state in FIG. 12A). Therefore, there may be generated a developer overflow in the development region, a carrier adhesion to the image bearing member, and an image degradation, such as a toner adhesion to a non-image portion (so called fog).

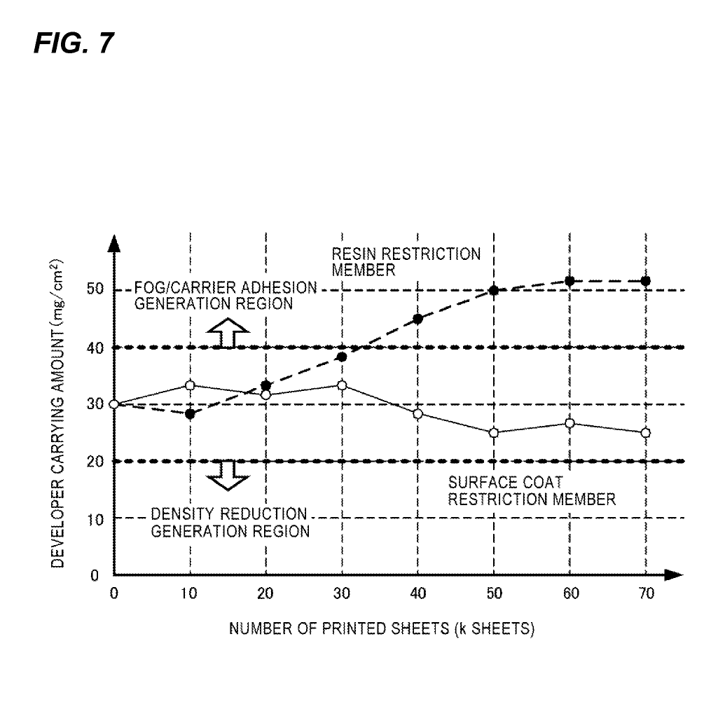

FIG. 7 shows changes of developer carrying amount on the surface of the development sleeve 4c in the development region with respect to the number of printed sheets for the developer layer restriction member 41 of a conventional resin molded part, and for the developer layer restriction member 41 of a resin molded part provided with the coat layer 41b on its surface.

As illustrated in FIG. 7, when the developer layer restriction member 41 of the conventional resin molded part is used, after twenty thousand of printed sheets, as mentioned above, due to the friction between the magnetic carrier and the developer layer restriction member 41, mainly the frictional wear of the restriction portion of the developer layer restriction member 41 proceeds, thereby enlarging the S-B gap. Therefore, the developer amount on the development sleeve 4c in the development region increases. Specifically, after thirty thousand of printed sheets the developer amount on the surface of the development sleeve 4c in the development region becomes 40 mg/cm² or more. As a result, the developer amount on the surface of the development sleeve 4c exceeds the developer amount threshold (40 mg/cm²) at which there are generated a developer overflow in the development region, a carrier adhesion to the image bearing member, an image degradation, such as a toner adhesion to a non-image portion (so called fog). Actually, after forty thousand of printed sheets, the carrier adhesion and the fog were generated.

On the other hand, when the developer layer restriction member 41 of the resin molded part provided with the coat layer 41b on its surface according to this embodiment is used, after forty thousand of printed sheets, the developer amount on the surface of the development sleeve 4c in the development region slightly decreases due to the toner adhesion to the developer layer restriction member 41. However, it is relatively stable for the long period until seventy thousand of printed sheets, and no image degradation is generated.

As described above, by using the development apparatus 4 using the developer layer restriction member 41 of the resin molded part provided with the coat layer 41b according to this embodiment, the cost of the development apparatus 4 can be lowered. Moreover, the developer overflow in the development region, which is caused by the fictional wear of the restriction portion of the developer layer restriction member which is generated by the friction between the developer and the developer layer restriction member, can be suppressed. Furthermore, the carrier adhesion to the image bearing member, the toner adhesion to a non-image portion (so called fog), and the image degradation, such as the density reduction, can be prevented so that a stable image forming can be performed for the long period.

### Second Embodiment

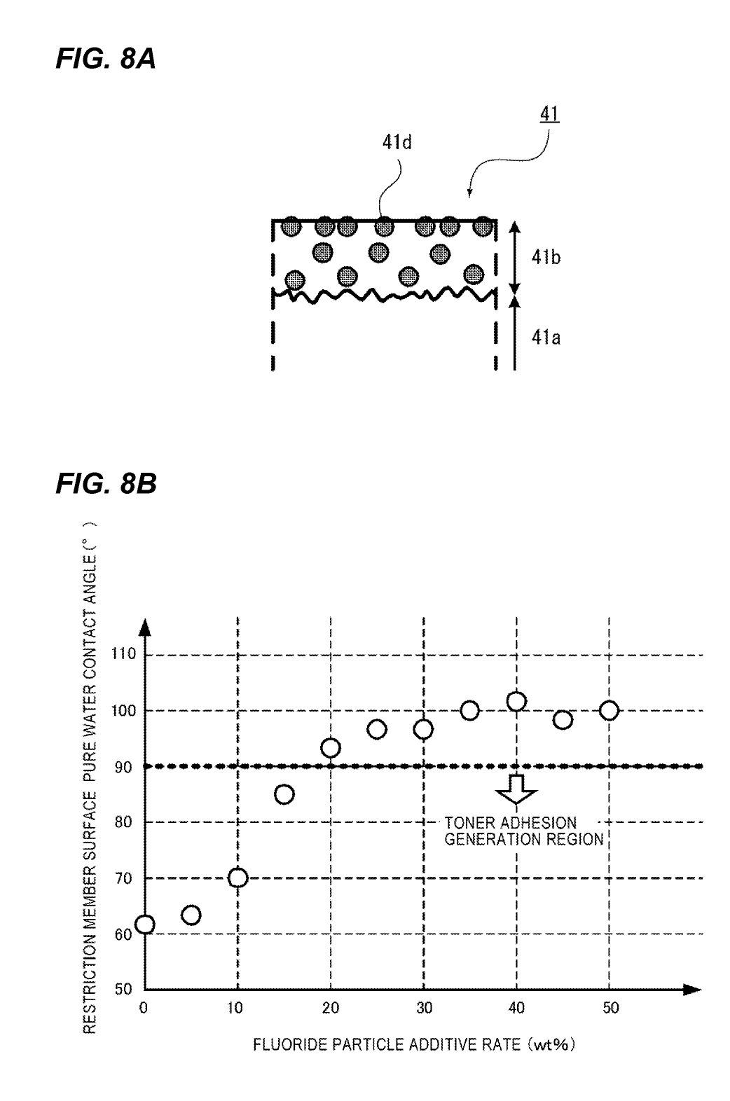

Next, the second embodiment of the developer layer restriction member and the development apparatus according to the present invention is described with reference to the drawing. Regarding the portions whose descriptions are redundant with those of the above-mentioned first embodiment, the same reference signs are designated and the descriptions are omitted. FIG. 8A is a partial cross-sectional view of the developer layer restriction member 41 according to this embodiment.

As illustrated in FIG. 8A, the developer layer restriction member 41 of this embodiment is configured by dispersing fluororesin particles 41c in the coat layer 41b of the developer layer restriction member of the above-mentioned first embodiment, and a part of the fluororesin particles 41c is exposed to the coat layer surface.

As mentioned above, by dispersing the fluororesin particles, and the like, which are resin components presenting a low surface free energy in the coat layer, and exposing a part of the particles on the coat layer surface, the adhesions of the fine powders of the toner and the external additives to the surface of the developer layer restriction member 41 can be prevented. With this, in addition to the advantageous effects of the above-mentioned first embodiment, the image degradation, such as the density reduction of image, due to the adhesions as clusters of the fine powders of the toner and the external additives on the surface of the developer layer restriction member 41, can be prevented, so that an image forming can be stably performed for the long period.

As fluororesin particles 41c, there can be mentioned polytetrafluoroethylene, polychlorotrifluoroethylene, polyvinylidene fluoride, polydichlorodifluoroethylene, tetrafluoroethylene-perfluoroalkylvinylether copolymer, tetrafluoroethylene-hexafluoropropylene copolymer, tetrafluoroethylene-ethylene copolymer, and the like. In this embodiment, polytetrafluoroethylene fine particles (brand name: Lubron; manufactured by Daikin Industries, Ltd.) having primary particle diameter of about 200 nm. As the method of measuring a particle diameter of polytetrafluoroethylene fine particles, about 50 particles are measured about their diameters by using the scanning electron microscope (S-4700 manufactured by Hitachi Corporation), the average value is determined as the particle diameter of polytetrafluoroethylene fine particles.

As the dispersing method of the fluororesin particles 41c, fluororesin particles 41c and a dispersing agent, such as fluorine modified acryl, of necessary amount are added to acrylic UV curing-type hard coat material (DeSolite manufactured by JSR Corporation) as a main material of the coat layer, and after that, a dispersion process is performed by using NMS-200ED manufactured by Nanomizer Inc.

FIG. 8B is a graph illustrating a relationship between an addition amount of the fluoride resin particles 41c added to the acrylic UV curing-type hard coat material as the main material of the coat layer and a pure water contact angle on the coat layer surface. When the fluoride resin particles 41c is 20 wt % or more, the pure water contact angle on the coat layer becomes 90° or more, so that the adhesions of the fine powders of the toner and the external additives to the developer layer restriction member 41 can be prevented. In this embodiment, the addition amount of the fluoride resin particles 41c to the acrylic UV curing-type hard coat material is 30 wt %, and the addition amount of the dispersing agent to the fluoride resin particles 41c is 5 wt %. Here, the pure water contact angle of the coat layer is measured by using a full automatic contact angle gauge DM-701 manufactured by Kyowa Interface Science Co., Ltd.

### Third Embodiment

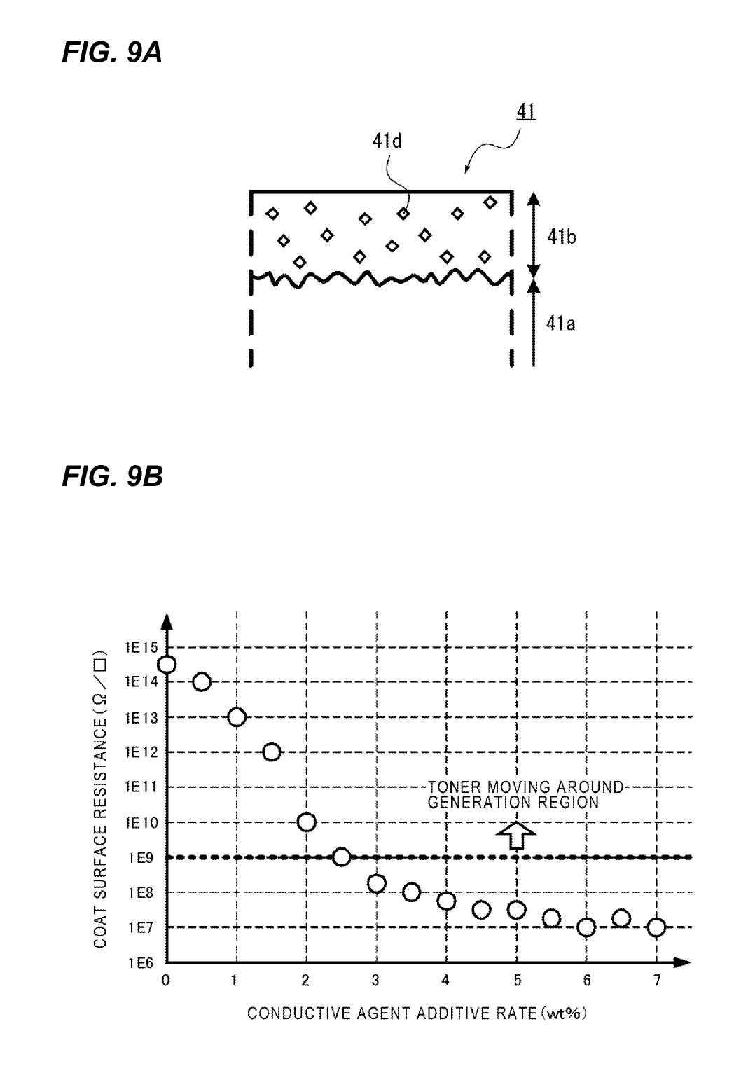

Next, the third embodiment of the developer layer restriction member and the development apparatus according to the present invention is described with reference to the drawings. Regarding the portions whose descriptions are redundant with those of the above-mentioned first embodiment, the same reference signs are designated and the descriptions are omitted. FIG. 9A is a partial cross-sectional view of the developer layer restriction member 41 according to this embodiment.

As illustrated in FIG. 9A, the developer layer restriction member 41 of this embodiment is configured by dispersing conductive particles 41d as a resistance adjustment agent in the coat layer 41b of the developer layer restriction member 41 of the above-mentioned first embodiment. The conductive particle 41d is a conductive inorganic fine particle.

FIG. 12D is a schematic diagram illustrating a state around the developer layer restriction member 41 in the case that the developer layer restriction member 41 of the conventional resin molded part is used. As illustrated in FIG. 12D, the developer carried on the development sleeve 4c adjacent to the restriction portion of the developer layer restriction member 41 is consolidated and the vacant space therein is small, so that the resistance becomes relatively low comparing to those of the other portions of the developer carried on the development sleeve 4c. When a high voltage is applied to the development sleeve 4c, the line of electric force from the development sleeve 4c adjacent to the developer layer restriction member 41 is not directed to the developer layer restriction member 41 because the developer layer restriction member 41 is a insulator, but is concentrated on the developer adjacent to the restriction portion of the developer layer restriction member 41 which has a relatively low resistance, and takes a locus returning to the development sleeve 4c. Therefore, the toner in the developer adjacent to the restriction portion of the developer layer restriction member 41 moves (segregates) in the developer on the surface or the development sleeve 4c. Most part of the toner moved to the surface of the development sleeve 4c is developed on the photoconductor drum 1 in the development region, but a part of the toner is not developed and moves around on the surface of the development sleeve 4c. As an increase of printing operations by the development apparatus 4, the amount of toner moving around on the development sleeve 4c increases, and a part thereof is fixedly adhered to the surface of the development sleeve 4c. In such a case, the S-B gap becomes smaller than the desired value, and the developer amount on the surface of the development sleeve 4c in the development region decreases. Accordingly, the contact area between the developer and the photoconductor drum 1 decreases, and the toner amount decreases, so that an image degradation, such as a density reduction of image, may be caused.

In the configuration of this embodiment, the resistance value of the coat layer 41b is adjusted by dispersing the conductive particles 41d in the coat layer, so that the voltages of the development sleeve 4c and the developer layer restriction member 41 are set to be the same with each other. Accordingly, a movement of the toner in the developer does not occur (a movement of only toner to the development sleeve surface does not occur), even when a high voltage is applied, an adhesion of the toner does not occur. With this, the moving around of the toner formed at the lower layer (adjacent to the surface of the development sleeve 4c) of the developer carried on the development sleeve 4c can be prevented. Therefore, in addition to the advantageous effects of the above-mentioned first embodiment, an image degradation, such as a density reduction of an image, due to the moving around of the toner on the surface of the development sleeve 4c can be prevented, and an image can be stably formed for a long period.

As the conductive material, there can be mentioned an inorganic conductive powder, such as carbon black particle, carbon fiber, or carbon nano-tube, or fibers, metal oxide, quaternary ammonium salt, and an ion conductive polymer, such as polyether ester amide. In this embodiment, the conductive particle of isopropyl alcohol sol (brand name: CELNAX; manufactured by Nissan Chemical Industries, Ltd.) which is zinc antimonite is used.

As the dispersing method of the conductive particles 41d, the conductive particles 41d of necessary amount are added to acrylic UV curing-type hard coat material (DeSolite manufactured by JSR Corporation) as a main material of the coat layer 41b, and after that, a dispersion process is performed by using NMS-200ED manufactured by Nanomizer Corporation. FIG. 9B illustrates a relationship between an addition amount of the conductive particles 41d to the acrylic UV curing-type hard coat material as a main material of the coat layer 41b and the surface resistance of the coat layer 41b. When the conductive particle 41d is 2.5 wt % or more, the surface resistance value of the coat layer 41b becomes 1E9 (Ω/□) or less (less than or equal to the surface resistance value of the magnetic carrier). Accordingly, the conduction between the development sleeve 4c and the developer layer restriction member 41 can be sufficiently ensured through the magnetic carrier. In the present embodiment, the addition amount of the conductive particles 41d to the acrylic UV curing-type hard coat material is set to be 5 wt %. Here, the surface resistance value of the coat layer is measured by a surface resistance/volume measuring device MODEL152-1 manufactured by TREK Japan Co. Ltd.

### Fourth Embodiment

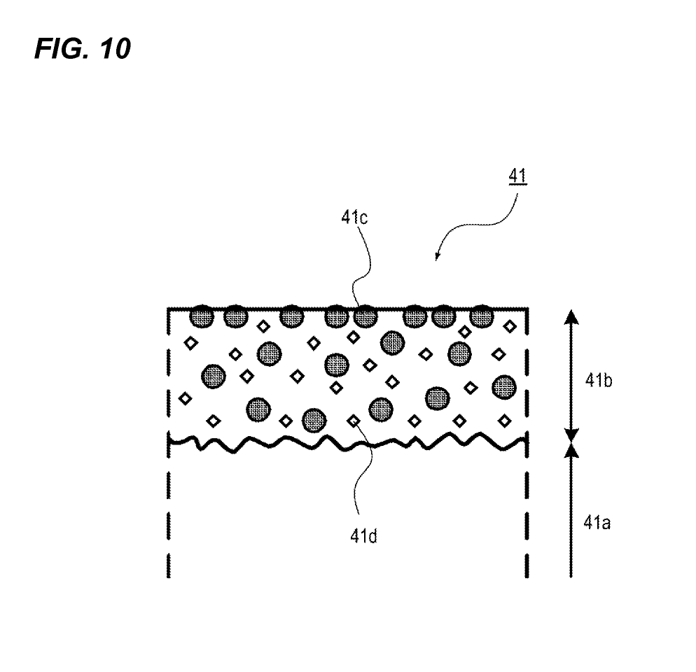

Next, the fourth embodiment of the developer layer restriction member and the development apparatus according to the present invention is described with reference to the drawings. Regarding the portions whose descriptions are redundant with those of the above-mentioned first embodiment, the same reference signs are designated and the descriptions are omitted. FIG. 10 is a partial cross-sectional view of the developer layer restriction member 41 according to this embodiment.

As illustrated in FIG. 10, the developer layer restriction member 41 of this embodiment is prepared by simultaneously dispersing the fluororesin particles 41c and the conductive particles 41d in the coat layer 41b of the developer layer restriction member 41 of the above-mentioned first embodiment.

Thus, by simultaneously dispersing the fluororesin particles 41c and the conductive particles 41d, the adhesions of the fine powders of the toner and the external additives to the surface of the developer layer restriction member 41, and also the moving around of the toner on the surface of the development sleeve 4c can be simultaneously prevented.

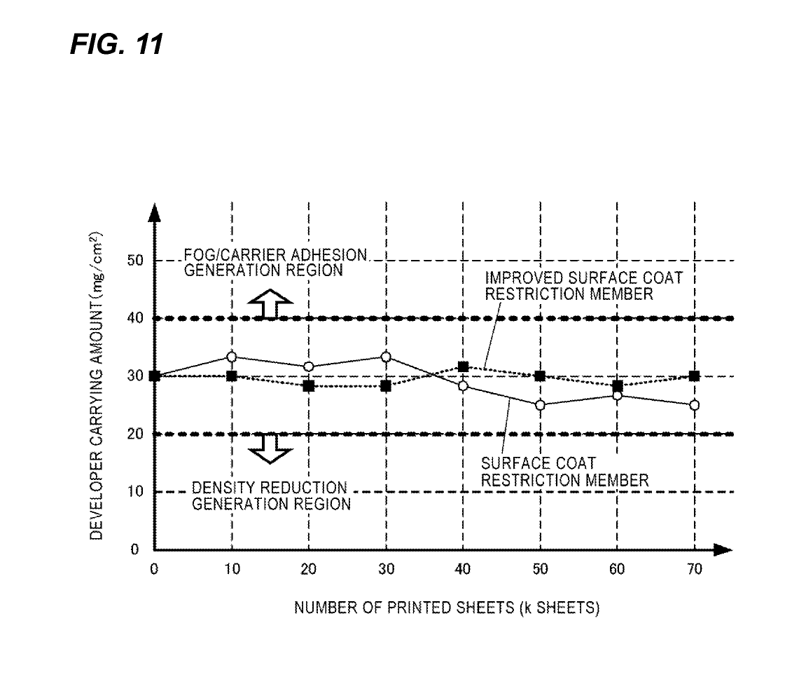

FIG. 11 illustrates changes of a developer amount which is carried on the surface of the development sleeve 4c in the development region with respect to a number of printed sheets of the development apparatus 4, in respective cases that the developer layer restriction member 41 of the above-mentioned first embodiment is used, and the developer layer restriction member 41 of this embodiment is used. As illustrated in FIG. 11, when the developer layer restriction member 41 of the above-mentioned first embodiment is used, after forty thousand of printed sheets, it can be understood that the developer amount on the surface of the development sleeve 4c in the development region slightly decreases due to the toner adhesion to the developer layer restriction member 41 and the moving around of the toner to the surface of the development sleeve 4c. On the other hand, when the developer layer restriction member 41 of this embodiment is used, even after forty thousand of printed sheets, the developer amount on the surface of the development sleeve 4c in the development region is extremely stable.

As described above, by using the developer layer restriction member 41 of the resin molded part provided with the coat layer 41b in which the fluororesin particles 41c and the conductive particles 41d are dispersed according to this embodiment, in addition to the advantageous effects of the above-mentioned first embodiment, the adhesions of the fine powders of the toner and the external additives on the surface of the developer layer restriction member 41 can be prevented, and also the image degradation, such as the density reduction of image due to the moving around of the toner on the surface of the development sleeve 4c can be prevented, so that an image can be stably formed for a long period.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2011-153162, filed Jul. 11, 2011, which is hereby incorporated by reference herein in its entirety.

What is claimed is:

1. A developer layer restriction member for restricting a developer amount held on a rotatable developer carrier which carries a developer and conveys the developer to a development region opposite to an image bearing member, the developer being made by mixing a non-magnetic toner and a magnetic carrier, comprising:
a substrate resin plate made of a resin; and
a resin hard coat layer disposed on a surface of the developer layer restriction member, the resin hard coat layer being made by coating the substrate resin plate with a resin which is harder than the resin of the substrate resin plate.

2. The developer layer restriction member according to claim 1, wherein a charging polarity of the resin hard coat layer is identical with a charging polarity of the non-magnetic toner when the magnetic carrier and the resin hard coat layer are frictionally charged.

3. The developer layer restriction member according to claim 1, wherein the resin hard coat layer is made of a UV curing resin.

4. The developer layer restriction member according to claim 3, wherein a main component of the UV curing resin is an acryl resin made of a polyfunctional acrylate.

5. The developer layer restriction member according to claim 1, wherein a resin component, which presents a low surface free energy, is included in the resin hard coat layer.

6. The developer layer restriction member according to claim 5, wherein the resin component presenting the low surface free energy is a polytetrafluoroethylene.

7. The developer layer restriction member according to claim 1, wherein a resistance adjustment agent is included in the resin hard coat layer.

8. The developer layer restriction member according to claim 7, wherein the resistance adjustment agent is a conductive inorganic fine particle.

9. The developer layer restriction member according to claim 7, wherein a surface resistance value of the resin hard coat layer is less than or equal to a surface resistance value of the magnetic carrier.

10. The developer layer restriction member according to claim 1, wherein the resin hard coat layer is disposed at least in a region which makes contact with the developer.

11. A development apparatus of a two-component development system, including a rotatable developer carrier which carries a developer and conveys the developer to a development region opposite to an image bearing member, the developer being made by mixing a non-magnetic toner and a magnetic carrier, an electrostatic latent image born on the image bearing member being developed as a toner image, comprising:
a developer layer restriction member according to claim 1 which restricts an developer amount held on the developer carrier.
